(19) United States
(12) Patent Application Publication
(10) Pub. No.: US 2010/0264827 A1
(43) Pub. Date: Oct. 21, 2010

(54) Control Device of Cup Lamp

(76) Inventors: Guo-Jhong HUANG, Jhongli City (TW); Shih-Jen Liao, Jhongli City (TW)

Correspondence Address: Jackson Intellectual Property Group PLLC, 106 Starvale Lane, Shipman, VA, 22971, US

(21) Appl. No.: 12/426,239

(22) Filed: Apr. 18, 2009

(51) Int. Cl. H05B 37/02

(52) U.S. Cl. 315/113; 315/297; 315/185 R

(57) ABSTRACT

A control device includes a rectification circuit, a filter circuit, a detection circuit, a voltage regulator circuit, a constant current circuit and at least one light emitting diode (LED). The rectification circuit is provided for receiving an input voltage of 5 to 24V, and the detection circuit is provided for detecting a quantity of LEDs and an actual required voltage to produce an actual required voltage value, such that the voltage regulator circuit and the constant current circuit can adjust an output current and an output voltage for the LED according to a detection result.

### BACKGROUND OF THE INVENTION

(a) Field of the Invention

The present invention relates to a control device of a cup lamp, in particular to a cup lamp control device capable of receiving an input voltage of 5 to 24V, and generating an actual required voltage value according to the quantity of connected light emitting diodes (LEDs) and the actual required voltage.

(b) Description of the Related Art

Traditional light bulb featuring simple structure and low price is used extensively as a light source, but a large amount of heat energy is produced during its use, thus resulting in a waste of energy. Furthermore, the light bulb also has the disadvantages of an unstable light source and a short life expectancy, and the light bulb tends to be replaced by LED light bulb gradually. The LED light bulb with the features of small size, power-saving and stable light emission provides us a good choice for the use of a light source.

The so-called “LED” is made of a semiconductor, and electrons and electron holes in the semiconductor are combined to emit photons. LED is a light emitting element capable of producing light spectra of different frequencies. In other words, the LED is a light emitting chip produced by combining an n-type semiconductor crystal and a p-type semiconductor crystal. After the LED is connected to an electric power, extra electrons of the n-type semiconductor crystal flow to the electron holes of the p-type semiconductor crystal. Due to the difference of electronic potentials, energy will be released when the electrons of the n-type semiconductor crystal fall into the electron holes of the p-type semiconductor crystal respectively. Energy is released in terms of light, and thus lights with different wavelengths will be produced.

During an operation of a general LED, a constant voltage is inputted to the LED to drive the light emitting chip to emit light or modulate an input voltage to drive a plurality of LEDs to produce changes of various different light colors at the same time. For instance, a multi-chip light emitting diode uses a voltage change to produce a different light color for each LED in order to achieve a color mixing effect. In the driving process, the requirement for a stable voltage mainly allows the LED to produce a stable light color, but an unstable light will still be produced in practical applications, and the main cause resides on the sensitive electric property of the LED. Although the input voltage can be controlled at a constant voltage, the material for making the LED and the packaging process of the LED will affect the voltage, and thus an LED generally labels or provides the positive and negative values of a required voltage for its application. In other words, an appropriate voltage difference falling within an ideal range between positive and negative values should be used for driving the LED. The situation is relatively stable if a single LED is driven by a constant voltage, but the situation will become unstable if a plurality of LEDs connected in series or in parallel are used. For example, a cup lamp available in the market has three LEDs connected in series with each other, and the required voltage difference is much higher, so that when the required voltage is used for driving the LEDs, the voltage difference and the current passing through the LED will be unstable, thus finally giving rise to an unstable light emitting condition. Furthermore, the temperature of the LED will rise rapidly, if the difference between the voltage difference and the driving voltage is too large. The input voltage cannot be adjusted according to the voltage difference in a traditional driving method, not only wasting energy, but also expediting the light attenuation and affecting the life expectancy of the LED.

### SUMMARY OF THE INVENTION

In view of the foregoing shortcomings of the prior art, the inventor of the present invention discloses a cup lamp control device capable of receiving an input voltage of 5 to 24V, and generating an actual required voltage value according to the quantity of connected light emitting diodes (LEDs) and the actual required voltage.

The control device of the invention comprises: a rectification circuit, a filter circuit, a detection circuit, a voltage regulator circuit, a constant current circuit and at least one LED, wherein the rectification circuit is used for receiving an input voltage of 5 to 24V, and the detection circuit is connected to the LED for detecting the quantity of LEDs and the actual required voltage for producing an actual required voltage value and transmitting a detection result to the voltage regulator circuit. After the input voltage has passed through the filter circuit, the detection circuit, the voltage regulator circuit and the constant current circuit, the voltage regulator circuit and the constant current circuit adjust the output current and the output voltage for the LED according to the detection result.

### BRIEF DESCRIPTION OF THE DRAWINGS

FIG. 1 is a perspective exploded view of a cup lamp of the present invention;

FIG. 2 is a schematic block diagram of a cup lamp of the present invention;

FIG. 3 is a schematic circuit diagram of a control device connected with an LED in series in accordance with the present invention; and

FIG. 4 is a schematic circuit diagram of a control device connected with an LED in parallel in accordance with the present invention.

### DETAILED DESCRIPTION OF THE PREFERRED EMBODIMENTS

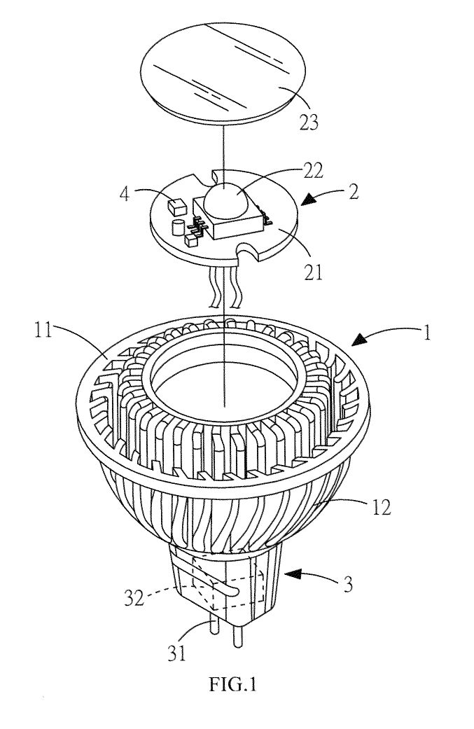

With reference to FIG. 1 for a control device of a cup lamp in accordance with the present invention, the cup lamp comprises a lampshade 1, an LED lamp set 2, and a power connector 3, wherein the lampshade 1 is made of a thermal conducting material such as aluminum, and includes a hollow cup-shaped body 11 and a plurality of heat dissipating fins 12 extended outward from the lateral periphery of the body 11 for dissipating heat. The LED lamp set 2 is installed in the lampshade body 11 and includes a circuit board 21, at least one LED 22 installed on the circuit board 21, and a lens 23 installed on the LED lamp set 2 and provided for the LED 22 to project light onto the lens 23. The power connector 3 is installed on the lampshade body 10 and includes a pin 31 protruded out of the power connector, and the power connector 3 has a transformer 32 installed therein, and the pin 31 is connected with the circuit board 21 through the transformer 32, and the transformer 32 is provided for converting an alternate current (AC) inputted to the pin 31 into a direct current (DC).

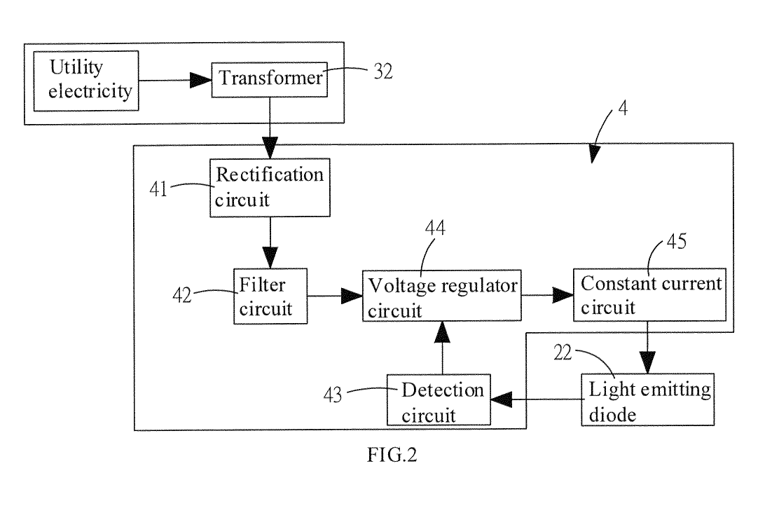

The circuit board 21 includes a control device 4 installed thereon for controlling each LED 22. In FIG. 2, the control device 4 comprises:

a rectification circuit 41, for receiving an input voltage of 5 to 24 volts direct current (VDC), or a 5 to 24 volts alternate current (VAC), wherein this embodiment adopts the input voltage of 5 to 24 VDC;

a filter circuit 42, connected to the rectification circuit 41, for receiving a rectified input voltage;

a detection circuit 43, with an end connected to the voltage regulator circuit 44 and another end connected to the LED 22, for detecting a quantity of LEDs 22 and an actual required voltage, for producing an actual required voltage value;

a voltage regulator circuit 44, with an end connected to the detection circuit 43 and another end connected to the filter circuit 42 for receiving the input voltage and adjusting the output voltage according to the actual required voltage value, wherein the voltage regulator circuit selects using a step-down circuit or a step-up circuit according to the difference between the input voltage and the actual required voltage, and if the input voltage is lower than the actual required voltage, then the voltage regulator circuit will be the step-up circuit, and if the input voltage is higher than the actual required voltage, then the voltage regulator circuit will be the step-down circuit;

a constant current circuit 45, connected to the voltage regulator circuit 44, for adjusting the output current according to the output voltage of the voltage regulator circuit 44, and also connected to the LED 22.

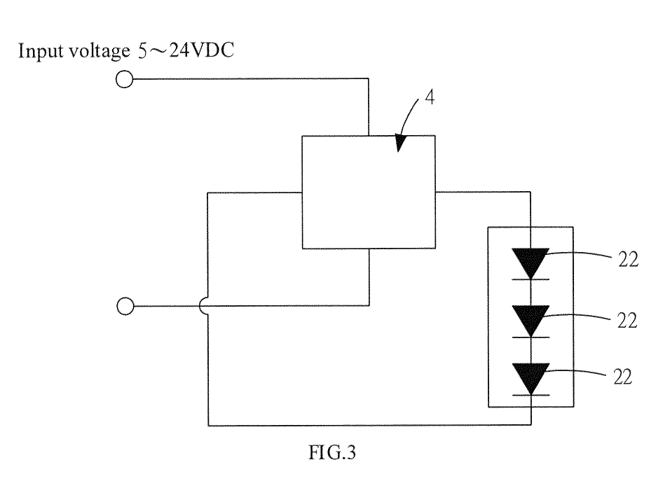

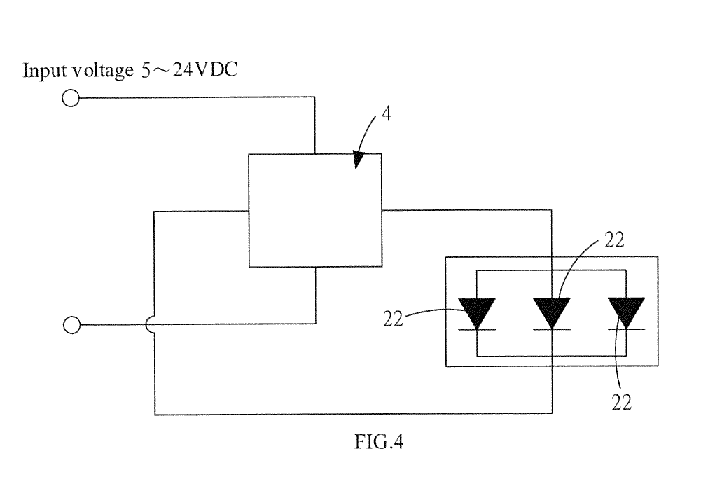

With reference to FIGS. 2 and 3 for a preferred embodiment of the invention, the cup lamp is connected to an external power supply by the power connector for inputting power to the cup lamp, and the input voltage is passed through the transformer to convert an alternate current (AC) into a direct current (DC), and the input voltage of the direct current (DC) is transmitted to the control device 4 on the circuit board. In the invention, the input voltage is 5˜24 VAC, rectified and filtered by the rectification circuit 41 and the filter circuit 42 respectively in sequence, and the detection circuit 43 transmits the actual required voltage value of the LED 22 to the voltage regulator circuit 44 after the detection circuit 43 has detected the input voltage. The output voltage is adjusted according to the actual required voltage value after the voltage regulator circuit 44 has received, rectified and filtered the input voltage, and finally the constant current circuit 45 adjusts the output current according to the output voltage of the voltage regulator circuit 44 and transmits the output voltage and the output current to the LED 22 to emit light. Of course, each LED 22 can be connected in series as shown in the figure, such that if each LED 22 is connected in series and the input voltage is lower than the actual required voltage, then the voltage regulator circuit is a step-up circuit, and if the input voltage is higher than the actual required voltage, then the voltage regulator circuit is a step-down circuit. Of course, the LEDs can be connected in parallel with each other as shown in FIG. 4, and thus the voltage regulator circuit is a step-down circuit.

It is noteworthy to point out that the control device of the invention not only receives an input voltage of 5 to 24V, but also adjusts the voltage and the stable current according to the actual quantity of LEDs connected with each other in series or in parallel and the actual required voltage to provide a more stable LED and assure the stability of its light emission.

In summation of the description above, the present invention improves over the prior art and complies with the patent application requirements, and thus is duly filed for patent application. While the invention has been described by means of specific embodiments, numerous modifications and variations could be made thereto by those skilled in the art without departing from the scope and spirit of the invention set forth in the claims.

I claim,:

1. A control device of a cup lamp, and the control device comprising:
a rectification circuit, for receiving an input voltage of 5 to 24 volts;
a filter circuit, connected to the rectification circuit, for receiving the input voltage after the input voltage is rectified;
a detection circuit, with an end connected to a voltage regulator circuit, and another end connected to a light emitting diode (LED), for detecting a quantity of LEDs and an actual required voltage to produce an actual required voltage value;
a voltage regulator circuit, with an end connected to the detection circuit, and another end connected to the filter circuit, for receiving the input voltage and adjusting an output voltage according to the actual required voltage value;
a constant current circuit, connected to the voltage regulator circuit, for adjusting an output current according to the output voltage of the voltage regulator circuit; and
at least one LED, for receiving the output current and the output voltage of the constant current circuit.

2. The control device of a cup lamp as recited in claim 1, wherein each LED is connected in series.

3. The control device of a cup lamp as recited in claim 2, wherein the voltage regulator circuit is a step-down circuit.

4. The control device of a cup lamp as recited in claim 2, wherein the voltage regulator circuit is a step-up circuit.

5. The control device of a cup lamp as recited in claim 1, wherein the LED is connected in parallel.

6. The control device of a cup lamp as recited in claim 5, wherein the voltage regulator circuit is a step-down circuit.

7. The control device of a cup lamp as recited in claim 1, wherein the cup lamp includes a lampshade, an LED lamp set and a power connector, and the LED lamp set is installed in the lampshade, and the power connector is installed on the lampshade.

8. The control device of a cup lamp as recited in claim 7, wherein the lampshade has a hollow cup-shaped body for containing the LED lamp set.

9. The control device of a cup lamp as recited in claim 8, wherein the body includes a plurality of heat dissipating fins extended outward from the lateral periphery of the body.

10. The control device of a cup lamp as recited in claim 8, wherein the LED lamp set includes a circuit board, at least one LED installed on the circuit board, and a lens installed on the LED lamp set and provided for the LED to project light thereon.

11. The control device of a cup lamp as recited in claim 10, wherein the power connector includes a pin protruded out of the power connector, and the power connector has a transformer installed therein, and the pin is connected with the circuit board through the transformer.

12. The control device of a cup lamp as recited in claim 7, wherein the LED lamp set includes a circuit board, at least one LED installed on the circuit board, and a lens installed on the LED lamp set and provided for the LED to project light thereon.

13. The control device of a cup lamp as recited in claim 12, wherein the power connector includes a pin protruded out of the power connector, and the power connector has a transformer installed therein, and the pin is connected with the circuit board through the transformer.

14. The control device of a cup lamp as recited in claim 1, wherein the input voltage is equal to 5 to 24 VDC.

15. The control device of a cup lamp as recited in claim 1, wherein the input voltage is equal to 5 to 24 VAC.
